(19) United States
(12) Patent Application Publication
(10) Pub. No.: US 2025/0247407 A1
(43) Pub. Date: Jul. 31, 2025

(54) NETWORK ANOMALY DETECTION WITH GRAPH ATTENTION NETWORK

(71) Applicant: Cisco Technology, Inc., San Jose, CA (US)

(72) Inventors: Xinqi Wang, Dalian (CN); Wunan Yang, Dalian (CN); Cheng Jiao, Beijing (CN); Weilin Chen, Shanghai (CN); Qihong Shao, Clyde Hill, WA (US); Shiyou Chen, Dalian (CN)

(21) Appl. No.: 18/428,703

(22) Filed: Jan. 31, 2024

(51) Int. Cl. H04L 9/40

(52) U.S. Cl. CPC H04L 63/1425

(57) ABSTRACT

A multi-instance learning and weakly supervised BGP anomaly detection framework is provided, that detects and analyzes significant statistical correlations across multiple data sources such as model driven telemetry (MDT), network messages, event data logs, and/or device configuration data for network topology. Specifically, methods are provided that involve obtaining, from a plurality of data sources, data related to operation or configuration of Border Gateway Protocol (BGP) in an enterprise network and extracting one or more BGP features based on at least one correlation among the data from the plurality of data sources. The methods further involve detecting one or more network anomalies by performing a weakly supervised machine learning of the one or more BGP features and providing information about the one or more network anomalies for performing one or more actions associated with the enterprise network.

### TECHNICAL FIELD

The present disclosure generally relates to computer networks and systems.

### BACKGROUND

In the realm of network infrastructure, a Border Gateway Protocol (BGP) was initially devised to connect independent Internet Service Providers (ISPs) on a global scale. Overtime, the BGP has emerged as the scalable and favored routing protocol for the entire expanse of the Internet. BGP not only facilitates the interconnection of the ISPs but has also garnered significant recognition for its efficacy in managing network connectivity within data center environments and the internal networks of ISPs.

### BRIEF DESCRIPTION OF THE DRAWINGS

FIG. 1 is a block diagram illustrating a system in which BGP anomalies are detected based on multi-instance, weakly supervised learning, according to an example embodiment.

FIG. 2 is a block diagram illustrating a system in which components of a BGP engine of FIG. 1 perform a weakly supervised BGP anomaly detection and root cause analysis using multi-source aggregation, according to an example embodiment.

FIG. 3 is a flow diagram illustrating an anomaly detection process for generating an anomaly score, according to an example embodiment.

FIG. 4 is a comparative view of a forecasted trend of data plane telemetry data and an actual trend of the data plane telemetry data for detecting a BGP anomaly event, according to an example embodiment.

FIG. 5A is a view illustrating a multi-instance learning process in which BGP message segments that correspond to a labeled network event are represented as a normal score space or an anomaly score space, according to an example embodiment.

FIG. 5B is a diagram illustrating a multi-instance based anomaly score learning process that uses a loss function to compute an anomaly score, according to an example embodiment.

FIG. 6 is a view illustrating a time window padding in which multi-source data is temporally correlated to determine a root cause of a detected anomaly, according to an example embodiment.

FIG. 7 is a view illustrating a BGP monitor user interface for providing information about detected anomalies and potential causes, according to an example embodiment.

FIG. 8 is a view illustrating a user interface for providing potential causes of a BGP anomaly ordered by a priority score, according to an example embodiment.

FIG. 9 is a flowchart illustrating a computer-implemented method of providing information about one or more detected network anomalies for performing one or more actions associated with the enterprise network based on weakly supervised machine learning of one or more BGP features, according to an example embodiment.

FIG. 10 is a hardware block diagram of a computing device that may perform functions associated with any combination of operations in connection with the techniques depicted and described in FIGS. 1-9, according to various example embodiments.

### DETAILED DESCRIPTION OF EXAMPLE EMBODIMENTS

### Overview

Techniques presented herein provide a multi-instance learning and weakly supervised BGP anomaly detection framework that detects and analyzes significant statistical correlations across multiple data sources such as model driven telemetry (MDT), network messages, event data logs, and/or device configuration data for network topology.

In one form, methods involve obtaining, from a plurality of data sources, data related to operation or configuration of Border Gateway Protocol (BGP) in an enterprise network and extracting one or more BGP features based on at least one correlation among the data from the plurality of data sources. The methods further involve detecting one or more network anomalies by performing a weakly supervised machine learning of the one or more BGP features and providing information about the one or more network anomalies for performing one or more actions associated with the enterprise network.

### EXAMPLE EMBODIMENTS

Border Gateway Protocol (BGP) is a routing protocol for the Internet. That is, BGP involves exchanging routing and reachability information (BGP messaging) among autonomous systems (e.g., ISPs) on the Internet. Networks that use BGP are inherently intricate and may be characterized by their dynamic nature.

Various anomalies can arise within BGP-based service providers and/or enterprise internal networks due to misconfigurations, routing errors, and/or equipment failures. To maintain network connectivity and thus, user satisfaction, these anomalies are detected and fixed. In other words, BGP anomalies are to be timely detected in these internal networks and actionable root causes of these BGP anomalies are to be identified at least because they serve as measures to uphold dependability and efficiency of BGP networks.

Some techniques for detecting BGP anomalies may involve time series analysis, machine learning, or statistical pattern recognitions. These techniques, however, are rather limited and are prone to false alarms. For example, label information independent unsupervised approach causes false alarms in BGP anomaly detection. Abrupt changes or surges in metrics of BGP messages may not necessarily indicate malicious activity but may be a result of traffic engineering for network load balancing or consequence of some link failure by natural causes.

Existing machine learning models with respect to BGP anomaly detection are based on a dataset constructed from records of BGP updates or telemetry data, which are partitioned into “anomalous” and “normal” samples. Recently, supervised machine learning models struggle to label BGP data. First, it is quite challenging to collect large amount of data for various available threats. Second, BGP abnormal events are difficult to collect and verify due to complicated commercial concerns. Third, with the fully labeled data approach, it is not possible to incorporate defenses against new or future threats.

The techniques presented herein provide a sizable comprehensive weak anomaly dataset using few-shot weakly supervised methods which utilize a limited number of labeled anomaly samples. The techniques involve an automated BGP event signal labeling and BGP root cause analysis based on multiple data sources such as BGP message router syslog and model driven telemetry (MDT). To address label uncertainty and in production or deployment environments, the BGP anomaly detection involves multi-instance learning based on weakly supervised anomaly detection. Specifically, weakly supervised learning is used to train a BGP anomaly detection model. Instead of classifying data as “normal” or “abnormal”, the BGP anomaly detection model learns an anomaly score of a given streaming BGP message. Since the multi-instance learning is only weakly supervised, false alarms may be prevented. Existing techniques are fuzzy with uncertainty such as streaming data could be inaccurate and uncertain in the time of network measurement and labeling may be erroneous and inaccurate. A weakly supervised learning BGP anomaly detection framework, on the other hand, trains the BGP anomaly detection model to avoid these uncertainties. Instead of classifying data as normal or abnormal, the techniques presented herein compute or learn an anomaly score of a given streaming BGP message.

Further, the techniques presented herein detect and analyze significant statistical correlations across multiple data sources. BGP-based service provider or enterprise internal network anomaly event is rare and lacks labeled BGP events. While unsupervised learning techniques are prone to false alarms and invisibility of the cause of the BGP events i.e., lack of detection, the techniques presented herein use additional data sources to diagnose an anomaly event and its root cause. The additional sources may include router syslog that is indicative of a device hardware status, BGP session, and services messages. The techniques presented herein also learn a normal pattern (e.g., trend, seasonality) of MDT (control plane and data plane features via Yet Another Next Generation (YANG) model) streaming data to detect an anomaly i.e., an anomaly signal.

Additionally, the techniques presented herein provide an automated BGP labeling engine. Assistant latent labels induce multi-view of the network status and then uncover anomaly events that are typically not detected, as well as chronic events for which symptoms keep reappearing and which may cause repeated performance degradation to users.

In addition to detecting anomalies, the techniques presented herein detect a root cause of an anomaly using BGP Root Cause Analysis (RCA) engine for troubleshooting anomalies (network issues) with multiple data view (multi-view) of the network. In addition to alarming and responding to each individual network problem, the techniques presented herein identify anomalies collectively, tracing their root causes and trends over time, which may help in driving corresponding failure modes out of the network and may eventually lead to service impartments. The techniques presented herein may further use mining temporal and spatial correlations to enable troubleshooting of BGP anomalies across multiple data sources.

While example embodiments described herein related to a BGP anomaly detection, the techniques are not limited thereto. The techniques may be applied to other routing or gateway protocols to detect network anomalies and diagnose their root causes.

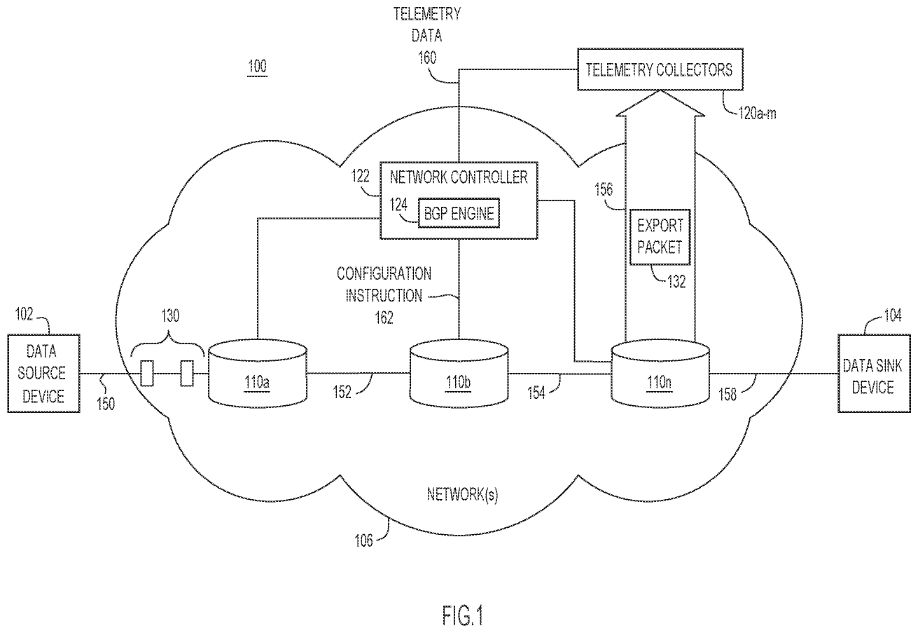

FIG. 1 is a block diagram illustrating a system 100 in which BGP anomalies are detected based on multi-instance, weakly supervised learning, according to an example embodiment. The system 100 includes a data source device 102, a data sink device 104, a plurality of network devices 110a-n that transport packet flows from the data source device 102 to the data sink device 104 across one or more network(s) 106 via network devices 110a-n, telemetry collectors 120a-m, and a network controller 122 that controls the network devices 110a-n.

The notations 1, 2, 3, . . . n; a, b, c, . . . n; “a-n”, “a-d”, “a-f”, “a-g”, “a-k”, “a-c”, and the like illustrate that the number of elements can vary depending on a particular implementation and is not limited to the number of elements being depicted or described. Moreover, this is only examples of various components, and the number and types of components, functions, etc. may vary based on a particular deployment and use case scenario. In other words, this is only an example of the system 100, and the number and types of entities may vary based on a particular deployment and use case scenario, such as the type of service being provided and network structures of various network(s) 106.

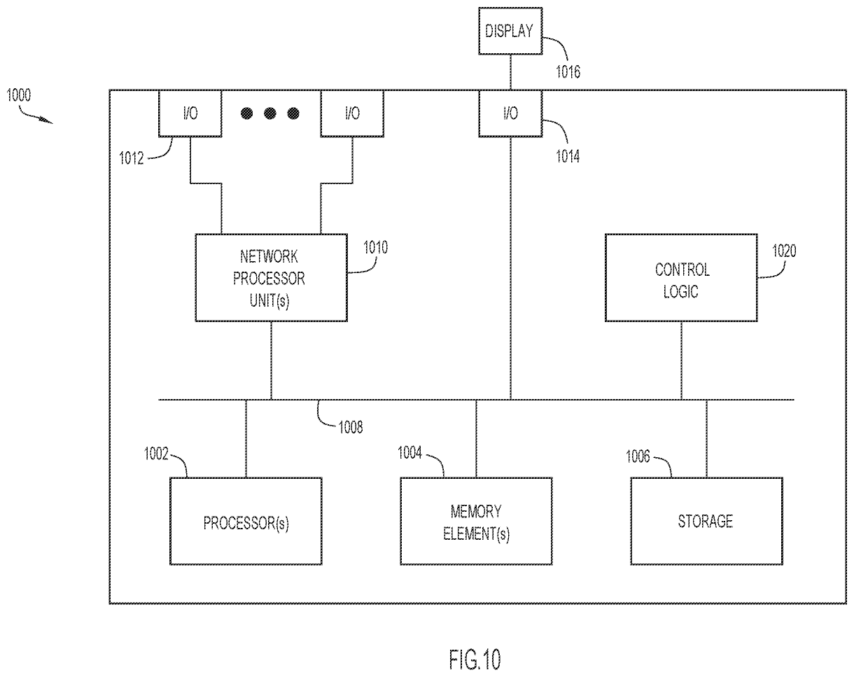

In various example embodiments, the entities of the system 100 (the data source device 102, the data sink device 104, the plurality of network devices 110a-n, the telemetry collectors 120a-m, and the network controller 122) may each include a network interface, at least one processor, and a memory. Each entity may be any programmable electronic device capable of executing computer readable program instructions. The network interface may include one or more network interface cards (having one or more ports) that enable components of the entity to send and receive data over the network(s) 106. Each entity may include internal and external hardware components such as those depicted and described in further detail in FIG. 10. In one example, at least some of these entities may be embodied as virtual devices with functionality distributed over a number of hardware devices such as virtual switches, routers, etc.

The data source device 102 and the data sink device 104 may be a computer or client device or an endpoint that generates data based on input from an operator or may be a service running on a server that responds to requests or performs actions based on the requests. The data source device 102 and the data sink device are connected via the network(s) 106, which may include several different networks that connect these two devices.

The network(s) 106 include the plurality of network devices 110a-n, which are transport nodes such as a network source device 110a, an intermediate network device 110b (transit node), and a network sink device 110n. The network devices 110a-n may include, but are not limited to switches, virtual routers, leaf nodes, spine nodes, etc. The network devices 110a-n include a central processing unit (CPU), a memory, a packet processing logic, an ingress interface, an egress interface, one or more buffers for storing various packets of various traffic flows, and one or more interface queues such as those depicted and described below. The network devices 110a-n use a gateway protocol such as a Border Gateway Protocol (BGP) to exchange routing and reachability information between peer network devices or nodes.

The telemetry collectors 120a-m may simply process and store telemetry data (e.g., MDT) for analysis by a different device. The telemetry collectors 120a-m may collect telemetry data from various data sources (not just the network devices 110a-n).

Telemetry data, sometimes called “collection data” or “measurement data”, are values obtained from monitoring i.e., monitoring by the network devices 110a-n performance of a network. The telemetry data includes various information such as identifiers, timestamps, interfaces visited, queue depth, etc., for each network device the packet traverses along the path. The network sink device 110n (the last network node along the path in the network such as decapsulating node may extracts the gathered telemetry data (in a form of metadata) from the received network packet and generate an export packet that includes the gathered metadata. The generated export packet is transmitted to one of the telemetry collectors 120a-m.

The telemetry collectors 120a-m may obtain telemetry data from various sources and provide to the network controller 122. For example, the telemetry data may include a model-driven telemetry data (MDT). MDT may be a continuous stream of various BGP features including real time configuration and operating state information of a respective network device. The MDT may use a YANG model to collect BGP features. For example, MDT may be obtained for BGP features selected by a user at an interval also defined by a user. The data being collected may further include system logging protocol data (syslog), which may be provided directly from a network device to the network controller 122. The syslog include event messages such as timestamps, device identifier (ID), Internet Protocol (IP) address, event description, event severity rating, and/or event specific information. Additionally, the network controller 122 may obtains configuration information such as router configuration including information about network interfaces or links that are connected and to which adjacent devices they are connected to, IP addresses, etc.

In one example embodiment, the telemetry collectors 120a-m may perform at least part of the analysis. That is, a telemetry collector may also be a network analysis entity or a software application that stores and analyzes gathered data to assess network performance or to perform a troubleshooting task. Based on analyzing the metadata, one or more network devices may be reconfigured e.g., to gather additional telemetry data, to change a network device setting, etc.

The telemetry collectors 120a-m may provide the telemetry data to the network controller 122. The network controller 122 may then analyze the telemetry data and configure one or more of the network devices 110a-n in the network(s) 106 based on this analysis. In one example embodiment, telemetry collector(s) and the network controller 122 are integrated into a single device that analyzes the metadata and controls the network devices 110a-n based on the analyzed metadata and rules or policies for the network(s) 106. The network controller 122 may provide a configuration instruction to a respective network device.

A traffic flow 130 includes a plurality of packets. A packet includes a header and a payload that carries data such as commands, instructions, responses, information, etc. As the packet traverses along the path through the network(s) 106, telemetry data may be added as aggregated metadata (metadata) to the header, for example. The telemetry data collected along the path may include one or more of: (1) network device related information such as switch level information (switch identifier), (2) ingress related information such as ingress interface identifier and/or ingress timestamp(s), (3) egress related information such as egress interface identifier, egress timestamp(s), hop latency, egress port transmission link utilization, (4) buffer related information such as queue occupancy level as experienced by the network packet, running average occupancy level, etc. In the system 100, the aggregated metadata may be collected as follows.

At 150, the data source device 102 generates the traffic flow 130. Each packet of the traffic flow 130 is transmitted to the network(s) 106 and is received by the network source device 110a. Each packet includes the header with a destination address or identifier, instructions for collecting telemetry data, etc. and the payload carrying data intended for the data sink device 104 (destination).

The network source device 110a analyzes the header of the packet to determine the next hop, and types of telemetry data to collect. The network source device 110a then adds or inserts its telemetry data set. At 152, the network source device 110a transmits or sends the packet to the next hop such as the intermediate network device 110b. The intermediate network device 110b similarly analyzes the header of the packet to determine the next hop, which telemetry data to collect. The intermediate network device 110b adds or inserts its respective telemetry data set. At 154, the intermediate network device 110b transmits the packet to the next hop such as the network sink device 110n. At this point, the metadata includes a plurality of telemetry node level metadata sets. That is, each telemetry node level metadata set is collected by a respective network node along a path in the network(s) 106 traversed by the packet of the traffic flow 130. The network sink device 110n generates an export packet 132 with the telemetry node level metadata sets. At 156, the network sink device 110n transmits the export packet 132 to one of the telemetry collectors 120a-m. The aggregated metadata is removed from the packet and the packet is transmitted to the data sink device 104, at 158.

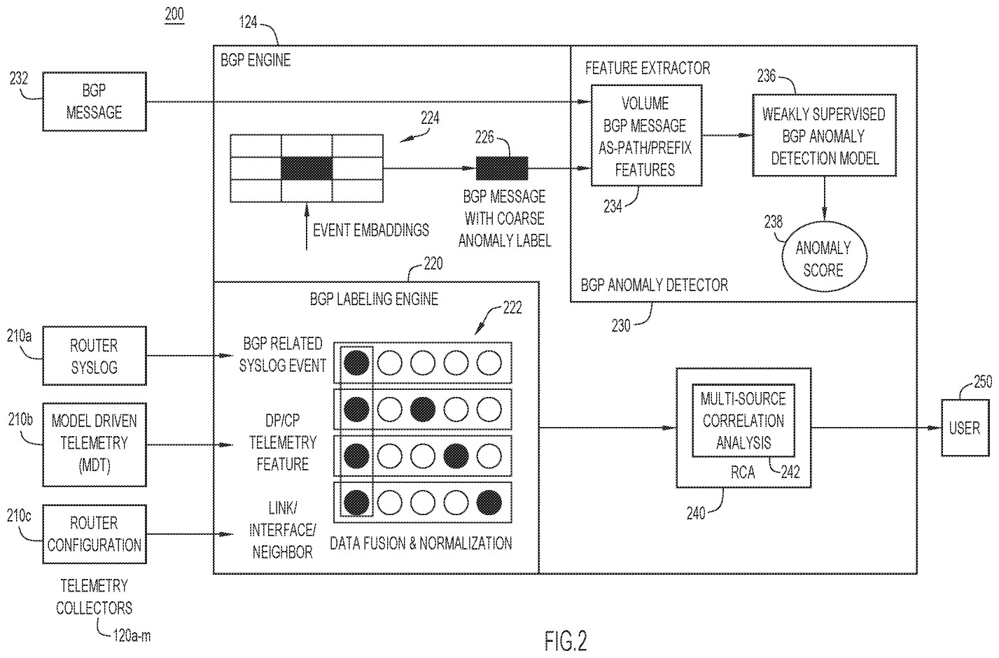

At 160, the telemetry collectors 120a-m provide the telemetry data to the network controller 122. The network controller 122 may include a BGP anomaly detector and root-cause analyzer, collectively referred to as a BGP engine 124. The BGP engine 124 extracts relevant information from the telemetry data and other data such as network configuration information and BGP messages. The BGP engine 124 performs weakly supervised BGP anomaly detection machine learning to generate an anomaly score. Based on the anomaly score, root cause analysis may be performed and cause reconfiguration of the intermediate network device 110b, via a configuration instruction, at 162. The BGP engine 124 is explained in further detail with reference to FIG. 2.

While the BGP engine 124 is shown as part of the network controller 122, this is just an example. In one or more example embodiments, the BGP engine 124 may involve a separate entity or a group of entities (e.g., servers) that perform multi-instance weakly supervised machine learning to detect one or more BGP related anomalies and determine their causes.

With continued reference to FIG. 1, FIG. 2 is a block diagram illustrating a system 200 in which components of the BGP engine 124 of FIG. 1 perform a weakly supervised BGP anomaly detection and root cause analysis using multi-source aggregation, according to an example embodiment. The system 200 includes telemetry collectors 120a-m of FIG. 1 and the BGP engine 124 that provides information about detected BGP anomalies and their causes to a user 250.

Today's IP networks are often heavily instrumented to continuously generate diverse measurements ranging from network-wide performance to routing protocol events and message logging (device syslog). The infrastructure of the BGP engine 124 enables troubleshooting of chronic network conditions by detecting and analyzing significant statistical correlations across multiple data sources. The BGP engine 124 may uncover or detect BGP chronic network conditions that typically fly under the operators' radar i.e., undetected by the user 250.

The BGP engine 124 obtains telemetry data from the telemetry collectors 120a-m. The telemetry collectors 120a-m may aggregate data from multiple different sources. For example, the data sources may include router syslog 210a, model-driver telemetry (MDT 210b), and router configuration 210c i.e., network configuration information. These are just some examples of the aggregated multi-source data and the disclosure is not limited thereto. The data may include any event logs, telemetry data, network configuration information, etc.

For example, router syslog 210a includes syslog messages that provide information about BGP announcement, update, withdraw, state changes, and error conditions encountered by a network device such as a routers, and/or other devices. The MDT 210b may be collected based on the process described in FIG. 1 or by streaming operation and performance related metric values directly from a respective network device, in real-time. The router configuration 210c includes information for mapping interfaces to routers, binding IP layer, layer 1/2 information of interfaces, etc. In other words, the router configuration 210c includes network device related information.

In one example embodiment, a data source may be a BGP monitoring tool that collects BGP updates, withdrawals, and advertisements data (using a BGP monitoring protocol). The telemetry collectors 120a-m pull diverse data sources together (e.g., aggregates the data from multiple sources), normalizes the collected telemetry data, partitions the telemetry data, and stores the partitioned telemetry data in a data store (not shown), for example, in real time.

The telemetry data 210a-c is provided to the BGP engine 124 that detects BGP anomalies and their root causes. The BGP engine 124 includes a BGP labeling engine 220, a BGP anomaly detector 230, and a BGP anomaly root cause analyzer (RCA 240).

The BGP labeling engine 220 obtains telemetry data from different data sources such as the router syslog 210a, the MDT 210b, and the router configuration 210c and embeds the telemetry data into data embeddings 222, which are then fused and normalized to generate event embeddings 224. Based on the event embeddings 224 (fused and normalized), anomaly labels 226 are generated. That is, the BGP labeling engine 220 generates BGP labels based on fusing and embedding network events data logs, the configuration information, and the MDT. The BGP labeling engine 220 is configured to detect latent anomalies i.e., anomaly events and generate new labels for unknown anomalies without input from the user 250. The BGP labels may be coarse anomaly level scores generated based on one or more deviations between a forecasted trend for the data and an actual trend of the data.

The BGP labeling engine 220 and the BGP anomaly detector 230 use an artificial intelligence (AI) analysis model (BGP metric anomaly detection model) that receives data 210a-c, extracts features such as statistical network features and network topology features, to capture BGP activity pattern, and detects an abnormal BGP event.

Specifically, the BGP anomaly detector 230 includes a feature extractor 234, weakly supervised BGP anomaly detection model 236 that generates an anomaly score 238. The feature extractor 234 obtains the BGP message 232, and based on the anomaly labels 226 (generated by the BGP labeling engine 220) extracts features to capture BGP activity pattern. Table 1 is an example of volume features and AS-path/prefix features from the BGP message 232 (an update message or update packets) that is received by the BGP anomaly detector 230.

| id | Feature | Type |
|---|---|---|
| 1 | AS-PATH length | AS- |
| 2 | Maximum/Average AS-PATH length | PATH/Prefix |
| 3 | Maximum/Average unique AS-PATH length | |
| 4 | Announcement to longer/shorter path | |
| 5 | Observation of rare ASes in the path | |
| 6 | Maximum/Average of rare ASes in the path | |
| 7 | AS-PATH change according to geographic location | |
| 8 | Prefix origin change | |
| 9 | Number of new paths announced after withdrawing | |
| | an old path | |
| 10 | Number of new-path announcements | |
| 11 | Total number of announcements/withdrawals/updates | volume |
| | per AS | |
| 12 | Number of announcements withdrawals/updates per | |
| | prefix | |
| 13 | Maximum/average announcements per prefix | |
| 14 | Number of duplicate announcements/withdrawals | |
| 15 | Number of new announcements | |
| 16 | Number of IGP, EGP, and INCOMPETE in the origin | |
| | attribute | |
| 17 | Number of re-announcements after a withdrawal | |
| 18 | Number of withdrawals transmitted to | |
| | unreachable prefix | |
| 19 | Number of withdrawals after announcing | |
| | the same path | |
| 20 | Number of unique prefixes originated by an AS | |
| 21 | Concentration ratio (first, second, third) | |

Relevant information is extracted from BGP update packets and is counted at certain intervals (e.g., one minute) to obtain several relevant feature values. As shown in Table 1, in general, these features can be divided into volume features (statistical volume metric values) and AS-PATH features (network topology features) such as the number of Network Layer Reachability Information (NLRI) prefixes announced or withdrawn, the average AS-PATH length, etc.

The weakly supervised BGP anomaly detection model 236 performs weakly supervised machine learning to generate the anomaly score 238. When anomalous BGP messages are detected based on the anomaly score 238, the RCA 240 is triggered to determine root cause and to act accordingly e.g., perform configuration actions. The RCA 240 performs both temporal and spatial correlation analysis (multi-source correlation analysis 242) on the suspicious anomaly BGP message and syslogs, then combines the knowledge library to obtain each correlated group's priority score. The RCA 240 determine a root cause of a network anomaly by grouping data from multiple data sources based on a temporal correlation and a spatial topology correlation. For example, the RCA 240 generates a first event group by grouping at least two log events in the network events data logs based on a temporal correlation and a spatial topology correlation and a second event group based on the MDT. A telemetry event in the second event group is a continuous pattern distortion of a predetermined time duration. The RCA 240 determines one or more potential causes of the one or more network anomalies by mapping the first event group with the second event group.

In one example, results may be provided to the user 250, and may involve one or more configuration actions.

In one example embodiment, the results are displayed to the user 250 and include all potential causes of an anomaly ordered by a priority score. That is, the RCA 240 may compute a priority score for each of the first event group and the second event group and correlate the first event group and the second event group based at least in part on the priority score, to determine a root cause of the one or more network anomalies based on the one or more potential causes.

The RCA 240 may compute a first priority score of a log event, which indicates an event occurrence frequency within a predefined time interval and a second priority score of the telemetry event, which indicates a duration of the telemetry event, and then rank potential causes based on the first priority score and the second priority score. The RCA 240 may the provide ranked potential causes to the user 250, as additional information. The root cause may be one of the following types: a routing network anomaly, a service level agreement anomaly, a failure of an interface of a network device in the enterprise network, a hardware failure of the network device, a software error in the network device, or a network security violation in the enterprise network.

The RCA 240 may compute a first priority score of a log event, which indicates an event occurrence frequency within a predefined time interval and a second priority score of the telemetry event, which indicates a duration of the telemetry event. The RCA 240 may then rank one or more potential causes of the one or more network anomalies based on the first priority score and the second priority score and providing additional information about the one or more potential causes of the one or more network anomalies including ranking that indicates likelihood of a respective potential cause being a root cause.

With continued reference to FIGS. 1 and 2, FIG. 3 is a flow diagram illustrating an anomaly detection process 300 in which an anomaly score is generated, according to an example embodiment. The anomaly detection process 300 is performed by the BGP engine 124 of FIGS. 1 and 2.

Specifically, the anomaly detection process 300 involves the BGP labeling engine 220 of FIG. 2 that generates bag-level labels (coarse labels for possible BGP anomalies) based on data from a plurality of sources and the BGP anomaly detector 230 of FIG. 2 that uses the generated coarse labels to generate anomaly scores based on which BGP anomalies are detected. The anomaly detection process 300 obtains, as input, multi-source data such as a BGP message 302, a router BGP syslog 304, and a model-driven telemetry data (MDT 306) and outputs an anomaly score for the BGP message 302, which is determined to be in a positive bag 362 for normal events or in a negative bag 364 for anomaly or uncertain events.

The anomaly detection process 300 starts at 308, with the BGP labeling engine 220 obtaining or receiving real-time BGP update information (the BGP message 302) from a BGP message collector (e.g., one of the telemetry collectors 120a-m of FIG. 1). At the same time (at 308), the BGP labeling engine 220 further collects network events data logs (the router BGP syslog 304) and telemetry data (the MDT 306). These additional data sources (the router BGP syslog 304 and the MDT 306) are then used to assign coarse grained normal or anomaly label to the BGP message 302.

With respect to the BGP message 302 (e.g., BGP update packets), the BGP labeling engine 220 obtains relevant information. In one example embodiment, the relevant information may involve statistical volume metric values 312 (e.g., total number of announcements or withdrawals) and network topology features 314 (e.g., AS-PATH metrics such as number of network layer reachability information (NLRI) prefixes announced or withdrawn, an average AS-PATH length). Some additional examples of these features are described in Table 1 above.

The BGP labeling engine 220 further analyzes the router BGP syslog 304 to detect a high volume of BGP issues in syslog 316a and the MDT 306 to detect telemetry key performance indicator (KPI) values from a YANG model that deviate from a predicted trend of these KPI values 316b.

At 318, the BGP labeling engine 220 analyzes the statistical volume metric values 312 and network topology features 314 of the BGP message 302 and assigns a bag-level label i.e., assign the BGP message 302 into a normal bag 320 or an anomaly bag 322. The statistical volume metric values that are unknown or abnormal are assigned to the anomaly bag 322.

Additionally, the anomaly detection process 300 involves, at 324, performing label alignment with respect to the BGP message 302 using additional data sources. A single type of data source sometimes does not provide sufficient information to decipher a complex network and its routing. Therefore, when collecting BGP data (the BGP message 302 that may include a plurality of packets with BGP events such as update notifications), the BGP labeling engine 220 also collects the router BGP syslog 304 and the MDT 306. The BGP labeling engine 220 automatically assigns to the BGP message 302 anomaly and normal labels using additional information extracted from these additional data sources, for improved accuracy and to detect new or unknown BGP anomalies.

For example, the BGP labeling engine 220 utilizes BGP syslog information (the router BGP syslog 304) to combat drawbacks of using BGP messages alone in Internet routing anomaly diagnosis. First, the BGP labeling engine 220 filters syslog related to BGP, and then determined the predefined anomaly levels of the problematic syslog events according to their different impacts on ISP service. Table 2 is one example of BGP-related issues in router BGP syslog 304, each with a corresponding predefined anomaly level. In this example, table 2 includes a type identifier (ID), a BGP issue type (syslog type), and an assigned anomaly level e.g., where four is the highest anomaly level representing a major network issue.

| | | Anomaly level |
|---|---|---|
| | | (4 is |
| Type id | Syslog Type | highest) |
| T1 | LINK-3-UPDOWN | 1 |
| T2 | LINEPROTO-5-UPDOWN | 1 |
| T3 | BGP-5-NBR_NSR_DISABLED_STANDBY | 2 |
| T4 | BGP-5-NSR STATE CHANGE | 1 |
| T5 | BGP-3-PATH CHUNK | 3 |
| T6 | BGP-5-ADJCHANGE | 1 |
| T7 | BGP-5-ADJCHANGE DETAIL | 1 |
| T8 | BGP-5-MAXPFX | 2 |
| T9 | BGP-5-NBR NSR DISABLED STANDBY | 2 |
| T10 | BGP-5-SENT NOTIF BADHOLDTIME | 1 |
| T11 | BGP-5-MAXPFXDISCARDPATH | 3 |
| T12 | BGP-4-L2VPN SIGNAL MISMATCH | 3 |
| T13 | BGP-3-NSR ERROR | 4 |
| T14 | BGP-3-INSUFMEM | 4 |
| T15 | BGP-5-RPKI ADJCHANGE | 3 |
| T16 | BGP-5-RPKI SSH KILL ERR | 4 |
| T17 | BGP-3-RPKI REPAIR | 3 |
| T18 | BGP-3-VRF CREATE | 2 |
| T19 | BGP-3-VRF DELETE | 3 |
| T20 | BGP-3-SRV6 INIT FAIL | 3 |
| T21 | BGP-4-BFD INVALID NBR | 3 |
| T22 | BGP-4-CLIENT ID OVERWRITE | 3 |
| T23 | BGP-4-RIB REG FAIL | 4 |
| T24 | BGP-2-ERR MEM ALLOC | 4 |
| T25 | BGP-3-AF LIB FILE ERROR | 3 |
| T26 | BGP-3-NSR ERROR | 3 |

In Table 2, BGP-3-PATH_CHUNK syslog (type ID “T5”) indicates an error associated with a path memory allocation. In particular, no path chunk was found large enough to store the path with the required bytes. The BGP labeling engine 220 uses syslog anomaly type and/or anomaly level to label the BGP message 302 into “normal” and “anomalous” samples (the normal bag 320 and the anomaly bag 322).

Moreover, high volume occurrence of BGP issues in syslog tends to prove that at this moment or in this time interval, the BGP may be malfunctioning i.e., not operating correctly. As such, the BGP message 302 is labeled as an anomalous sample(s). In contrast, no occurrence of BGP issues in syslog for a predetermined period (a set time interval) is labeled as normal sample(s).

To further determine whether syslog messages (the router BGP syslog 304) in a specific time range are to be labeled as a BGP anomaly event or a normal event, the BGP labeling engine 220 may compute a syslog event anomaly level score based on the following equation (1):

$$anomaly level score = {\sum }_{i = 1}^{N} {e}^{{l}_{Ti}} * {f}_{{T}_{i}} \qquad ( 1 )$$

where l_{Ti} is an anomaly level of the syslog type (shown in Table 2 above), f_{Ti} is a syslog frequency count of a log type Ti in the present interval, and N is a total amount of BGP related syslog type.

When the computed anomaly level score is higher than a configured threshold, the BGP labeling engine 220 labels the router BGP syslog 304 as an anomalous BGP event (in the anomaly bag 322) and may generate an anomaly BGP event signal.

At 324, the label alignment further involves the MDT 306. In the MDT 306, control plane (CP) and data plane (DP) via Yet Another Next Generation (YANG) features may contribute to detecting BGP failures or anomalies. The BGP labeling engine 220 adds telemetry data as another data source to improve accuracy of the BGP anomaly event labels. Table 3 is one example of relevant control and data plane key performance indicators (KPIs) specific to domain knowledge. Table 3 illustrates BGP related control plane and data plane MDT feature list via YANG model, according to one example embodiment. Specifically, the MDT feature list includes a plane type (data plane or control plane), a description of a feature instance, and a location level (e.g., interface or node).

| Plane | Feature instance | Location level |
|---|---|---|
| Data | input-data-rate | interface |
| | output-data-rate | |
| | input-load | |
| | output-load | |
| | input-packet-rate | |
| | output-packet-rate | |
| | reliability | |
| | total-cpu-one-minute | node |
| | system-ram-memory | |
| | no-route-memory | |
| | incomplete-adjacency-packets | |
| | free-physical-memory | |
| | free-application-memory | |
| control | deleted-routes-count | node |
| | global-established-neighbors-count | |
| | protocol-route-memory | |
| | backup-routes-count | |
| | deleted-routes-count | |
| | global_neighbors-count-total | |
| | global_nexthop-count | |
| | global_establishedneighbors-count-total | |
| | paths-count | |
| | performancestatistics_global_{—} | |
| | ipv4ribserver_is-rib-connection-up | |
| | performancestatistics_global_{—} | |
| | configuration-items-processed | |
| | performancestatistics_global_{—} | |
| | ipv4ribserver rib-connection-upcount | |
| | routes-counts | |
| | route-table-name | |
| | vrf-name | |
| | vrf_neighbors-count | |
| | vrf_network-count | |
| | vrf_path-count | |

Using the MDT 306 to label BGP events may be helpful because telemetry data follows certain patterns. For example, feature instances in a BGP-based SP or an enterprise internal network are distributed in a certain interval or change with seasonality. If these feature instances substantially fluctuate, which is detected by time series forecasting techniques, these fluctuations may be indicative of BGP anomalies. As such, the BGP labeling engine 220 applies residual analysis to determine if a BGP anomaly event signal is to be triggered/generated. Using the MDT 306 helps the BGP labeling engine 220 to detect BGP anomalies with respect to the BGP message 302.

In one example embodiment, to evaluate stability and/or seasonality of selected key performance indicators (KPIs) of the MDT 306, machine learning is performed to learn KPIs normal patterns. The BGP labeling engine 220 generates a plurality of BGP labels, which are coarse anomaly level scores that are further based on deviations between a forecasted trend for the MDT 306 and an actual trend of the MDT 306.

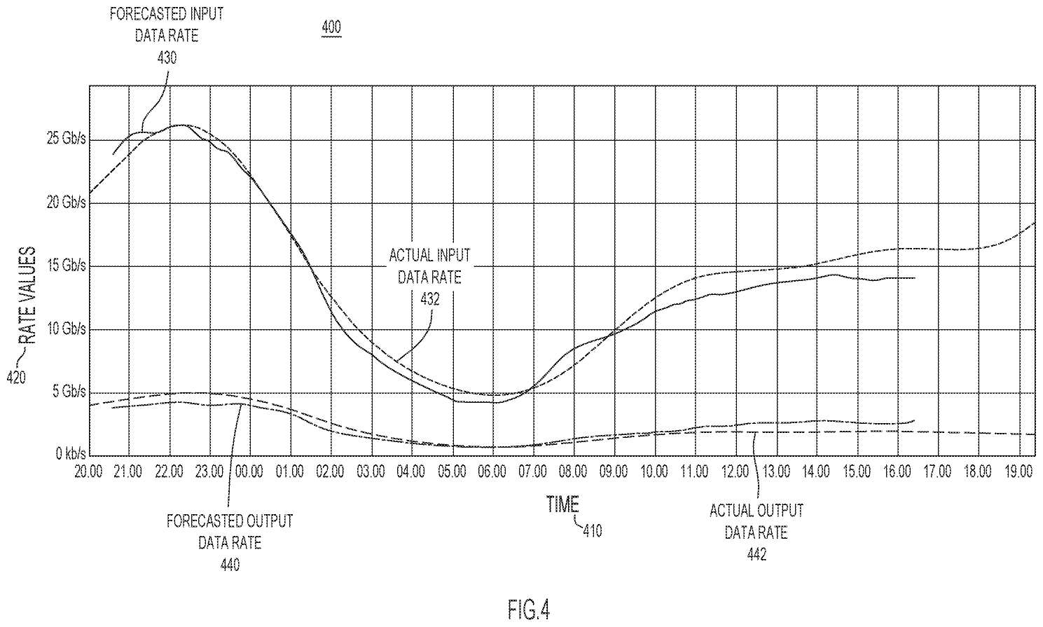

FIG. 4 is a comparative view 400 of a forecasted trend of data plane telemetry data and an actual trend of the data plane telemetry data for detecting a BGP anomaly event, according to an example embodiment. In the comparative view 400, x-axis are time values 410 and y-axis are rate values 420 in gigabits per second (Gb/s).

The BGP labeling engine 220 applies machine learning to learn and verify KPI trends. That is, the BGP labeling engine 220 learns and forecasts MDT trends and compares them to actual MDT values to detect statistically significant deviations that may be indicative of a BGP anomaly event.

In one example embodiment, the BGP labeling engine 220 may select telemetry data types for BGP anomaly event detection features such as an input data rate and an output data rate. These two MDT KPIs may represent the BGP anomaly event signal detection features. The BGP labeling engine 220 may apply a prophet algorithm to learn and predict the input data rate and the output data rate on an interface of a network device e.g., a router interface. The BGP labeling engine 220 compares the forecasted MDT trends to actual MDT values to compute an average deviation, which is indicative of whether an anomaly event is occurring.

Specifically, in the comparative view 400, a forecasted input data rate 430 and an actual input data rate 432 are determined for a predetermined time interval. The BGP labeling engine 220 then computes an average input rate deviation. Similarly, a forecasted output data rate 440 and an actual output data rate 442 are determines for the same predetermined time interval. The BGP labeling engine 220 then computes an average output rate deviation. These average deviations between the forecasting trend and the actual input/output data trends is the anomaly event trigger signal i.e., when the deviations are about a set threshold, the anomaly event trigger signal is generated.

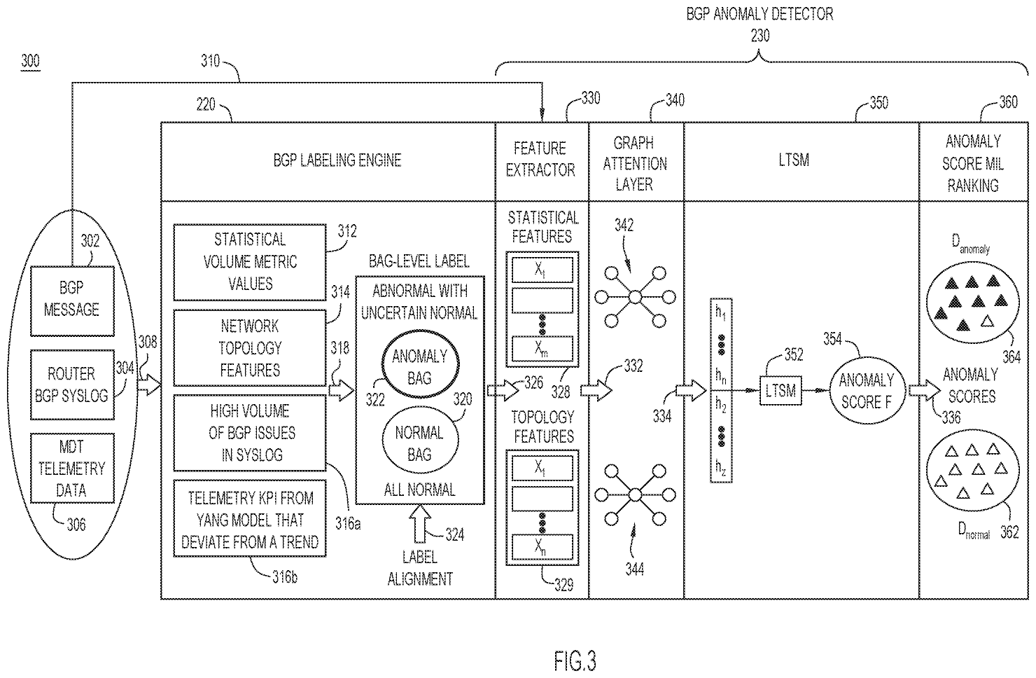

Referring back to FIG. 3, at 326, the BGP anomaly detector 230 obtains bag-level labels (coarse labels) from the BGP labeling engine 220 and uses these labels to generate anomaly scores (normal anomaly scores in a positive bag 362 and abnormal anomaly scores in a negative bag 364). The BGP anomaly detection network includes a feature extractor 330, a graph attention layer 340, a long short-term memory layer (a LSTM layer 350), and an anomaly score multi-instance learning (MIL) ranking (a MIL ranking 360).

Specifically, at 310, the feature extractor 330 obtains the BGP message 302 (e.g., BGP update packets). The feature extractor 330 performs feature extraction in which relevant information from BGP update packets is extracted and counted, as intervals of one minute for example, to obtain several relevant features values. The interval length may vary based on a particular deployment and use case scenario. Specifically, the BGP anomaly detector 230 extracts statistical features 328 and topology features 329 of the BGP message 302 (i.e., from the BGP update packets at a predetermined time interval). Some examples of feature types are provided in Table 1 above. The features are embedded to generate feature embeddings or feature vectors, which are fused together based on correlation analysis.

The BGP anomaly detector 230 models a BGP anomaly detection network with multi-instance learning (MIL) based weakly supervised framework.

At 332, the graph attention layer 340 obtains a set of feature vectors and explores the interrelationship between each feature. For example, the graph attention layer 340 generates a graph attention network (GAT) that includes a first graph 342 and a second graph 344, which are indicative of the one or more interrelationships between the statistical features 328 and the topology features 329. The GAT is a temporal and spatial mixture feature-based graph attention network. In one example embodiment, the first graph 342 is generated for extracting information (correlations) form the statistical features 328 (e.g., x1, . . . , xm) and the second graph 344 is for extracting information (correlations) from the topology features 329 (e.g., x1, . . . , xn).

For example, the graph attention layer 340 may determine a spatial correlation between volume metric values of a statistical network feature and network layer reachability information (NLRI) metrics of a network topology feature e.g., as occurring at the same network device, interface, or link. The graph attention layer 340 may further determine a temporal correlation between the volume metric values of the statistical network feature and the network layer reachability information metrics of the network topology feature e.g., as occurring at substantially same time interval. As such, the generated graph attention network (GAT) captures spatial-temporal correlation of an AS-path graph feature (i.e., a network topology features) and a BGP volume feature (i.e., statistical volume metric values).

In one example embodiment, the BGP anomaly detector 230 applies the following equations (2) and (3) to generate the GAT.

$${h}_{i}^{′} = δ ( {\sum }_{j ϵ {N}_{i}} {α}_{ij} W {h}_{j} ) \qquad ( 2 )$$

$${α}_{ij} = \frac{exp ( LR ( {a}^{T} [ {wh}_{i} \vert \vert {wh}_{j} ] ) )}{{\sum }_{k ∈ {N}_{i}} exp ( LR ( {a}^{T} [ {wh}_{i} [ [ {wh}_{k} ] ) )} \qquad ( 3 )$$

where hi is the input feature of a node I, hi′ is the new feature vector of node i, Ni represents the set of all neighbors of the node I, aij is attention coefficient in GAT. “W” and “a” are the weight matrix parameters.

At 334, the LSTM layer 350 predicts or computes an anomaly score 354 based on the interrelationships obtained from the GAT (the first graph 342 and the second graph 344) generated by the graph attention layer 340. The LSTM layer 350 applies long short-term memory network (LSTM 352) to estimate the anomaly score 354.

At 336, the anomaly score 354 is provided to the MIL ranking 360, which trains the networks by utilizing a ranking loss function to compute ranking loss between the highest scored instances in the positive bag 362 (normal scores bag) and the negative bag 364 (abnormal scores bag). In one example embodiment, f(Danomaly) of the abnormal anomaly scores is greater than f(Dnormal) of the normal anomaly scores.

The BGP anomaly detector 230 applies a weakly supervised anomaly detection framework to generate coarse grained labels as opposed to normal/abnormal to improve anomaly detection and to learn new/previously unknown BGP anomalies. Abnormal BGP events may be rare and diverse. It is thus difficult to collect and label all kinds of anomalies for modeling. Moreover, some samples remain uncertain and cannot be labeled as normal events or anomalies. Further, inaccurate event timestamps from various data sources may cause errors. Delay often exists between when a syslog event occurs and when it shows up in BGP measurement data. As such, normal samples may be mixed in a labeled abnormal time window.

Some methods formulate BGP anomaly detection as an unsupervised task. Unsupervised methods may use normal samples to learn “normality,” and then the anomaly may be detected by measuring its deviation to the learned “normality”. Due to the lack of observation of abnormal events, these methods may not learn significant differences between normality and anomaly.

In contrast, the BGP anomaly detector 230 uses a weakly supervised anomaly detection to detect anomalies by comparing normal BGP message data and abnormal BGP message data with syslog assisted labels, examples of which are described above. The BGP anomaly detector 230 uses a limited labeled anomaly data and a large unlabeled data when training machine learning model such that the BGP anomaly detector 230 learns to generalize from a few labeled known anomalies to detect both known and unknown anomalies. Additionally, the weakly supervised anomaly detection is formulated as a multi-instance learning (MIL). Since the BGP anomaly detector 230 uses a MIL based weakly supervised framework model performance may be improved or be more accurate and may detect new anomalies or chronic BGP anomalies that typically are undetected.

With continued reference to FIGS. 1-3, FIG. 5A is a view illustrating a multi-instance learning process 500 in which BGP message segments that correspond to a labeled network event are represented as a normal score space or an anomaly score space, according to an example embodiment. The multi-instance learning process 500 involves multi-source or telemetry data 502a-k such as a telemetry data flow 502a, a syslog data flow 502b to form an event aggregation 502c, and a BGP data flow 502k, a temporal sliding window 504 that represents an instance in a normal bag 506 or an anomaly bag 508.

In general, multi-instance learning may be designed for predicting a label of a bag/set of instances, rather than a label of an individual instance e.g., normal and abnormal videos are regarded as positive and negative bags, respectively, and video segments as instances. Similarly, in the multi-instance learning process 500, the temporal sliding window 504 is used to segment the BGP data flow 502k into multiple event instances 510a-j such as a first set of instances 510a, a second set of instances 510b, a third set of instances 510c, and a fourth set of instances 510j. For each set of instances, the BGP anomaly detector 230 determines whether the instance set is a BGP anomaly, a normal BGP event, or an uncertain BGP event.

For example, the BGP anomaly detector 230 determines that the first set of instances 510a is an anomaly i.e., labeled anomaly instances. That is, while telemetry data flow 502a that is temporally correlated to the first set of instances 510a, indicates regular traffic 522, the syslog data flow 502b that is temporally correlated to the first set of instances 510a, indicates an anomaly syslog event 532. By aggregating these two elements (performing temporal and/or spatial correlations), the event aggregation 502c of the first set of instances 510a is determined to be an anomaly event 542. Thus, the first set of instances 510a are assigned to the anomaly bag 508 such as first anomalies (Ba1 552a).

The BGP anomaly detector 230 determines that the second set of instances 510b is a mixed group of events. The telemetry data flow 502a that is temporally correlated to the second set of instances 510b, indicates regular traffic 522 but the syslog data flow 502b that is temporally correlated to the second set of instances 510b, indicates an uncertain syslog event 534. In other words, the uncertain syslog event 534 is not known e.g., a new event that was not previously encountered and learned by the BGP anomaly detector 230. By aggregating these two elements (performing temporal and/or spatial correlations), the event aggregation 502c of the second set of instances 510b is determined to be an uncertain event 544. That is, the second set of instances 510b are determined to be unlabeled anomaly instances with some normal instances therein. Since the second set of instances 510b includes unlabeled anomaly instances, the BGP anomaly detector 230 assigs the second set of instances 510b to the anomaly bag 508 such as second anomalies (Ba2 552b).

The BGP anomaly detector 230 determines that the third set of instances 510c is a group of normal BGP events. The telemetry data flow 502a that is temporally correlated to the third set of instances 510c, indicates the regular traffic 522 and the syslog data flow 502b that is temporally correlated to the third set of instances 510c, indicates normal event 546. By aggregating these two elements (performing temporal and/or spatial correlations), the event aggregation 502c that correlates to the third set of instances 510c, is determined to be a normal event 546. As such, the BGP anomaly detector 230 assigs the third set of instances 510c to the normal bag 506 such as normal BGP events (Bn1 554a).

Analogously, the BGP anomaly detector 230 determines that the fourth set of instances 510j is a group of abnormal BGP events. The telemetry data flow 502a that is temporally correlated to the fourth set of instances 510j indicates suspicious abnormal traffic 524 and the syslog data flow 502b that is temporally correlated to the fourth set of instances 510j, indicates the normal BGP event 536 and an anomaly syslog event 538. By aggregating these two elements (performing temporal and/or spatial correlations), the event aggregation 502c that correlates to the fourth set of instances 510j, is determined to be an abnormal event 548. As such, the BGP anomaly detector 230 assigs the fourth set of instances 510j to the anomaly bag 508 such as abnormal BGP events (Ba3 552c).

The BGP anomaly detector 230 classifies both abnormal BGP instances and uncertain BGP instances in the anomaly bag 508 and classifies normal BGP instances in the normal bag 506. As such, every instance, which is a multi-dimensional time series with a fixed window size from BGP streaming message features, is classified into one of the two bags. The BGP anomaly detector 230 is trained using these instances being classified into one of these two bags.

With continued reference to FIGS. 1-5A, FIG. 5B is a diagram illustrating a multi-instance based anomaly score learning process 550 that uses a loss function to compute an anomaly score, according to an example embodiment. The multi-instance based anomaly score learning process 550 may be performed by the BGP anomaly detector 230 of FIG. 2.

Since anomalies usually have distinct patterns, existing methods may easily fail to distinguish these anomalies from normal nodes in a latent representation space with only few labeled anomalies, while they may be separated in a first anomaly score space 560 by enforcing statistically significant deviations between abnormal data and normal data. Specifically, the first anomaly score space 560 includes a labeled anomaly 562, an unlabeled anomaly 564 that represent unknown or uncertain events, and a normal event 566. At least some of these uncertain events may be in a normal event space, shown at 568.

At 570, the BGP anomaly detector 230 performs MIL-based methods to learn a larger anomaly score for the most abnormal instance in anomaly segments than that in normal segments via a bag-wise ranking loss. Using the bag-wise ranking loss function, the BGP anomaly detector 230 identifies anomalous BGP data segments that have higher anomaly scores than the normal segments. Using a ranking loss function, the BGP anomaly detector 230 encourages high scores for anomalous segments and lower scores for normal segments. As such, in a second anomaly score space 580, instances identified as the labeled anomaly 562 have the highest anomaly score, shown at 582, instances identified as the unlabeled anomaly 564 may have lower anomaly scores, shown at 584, and instances identified as normal event 566 may have the lowest anomaly scores, shown at 586.

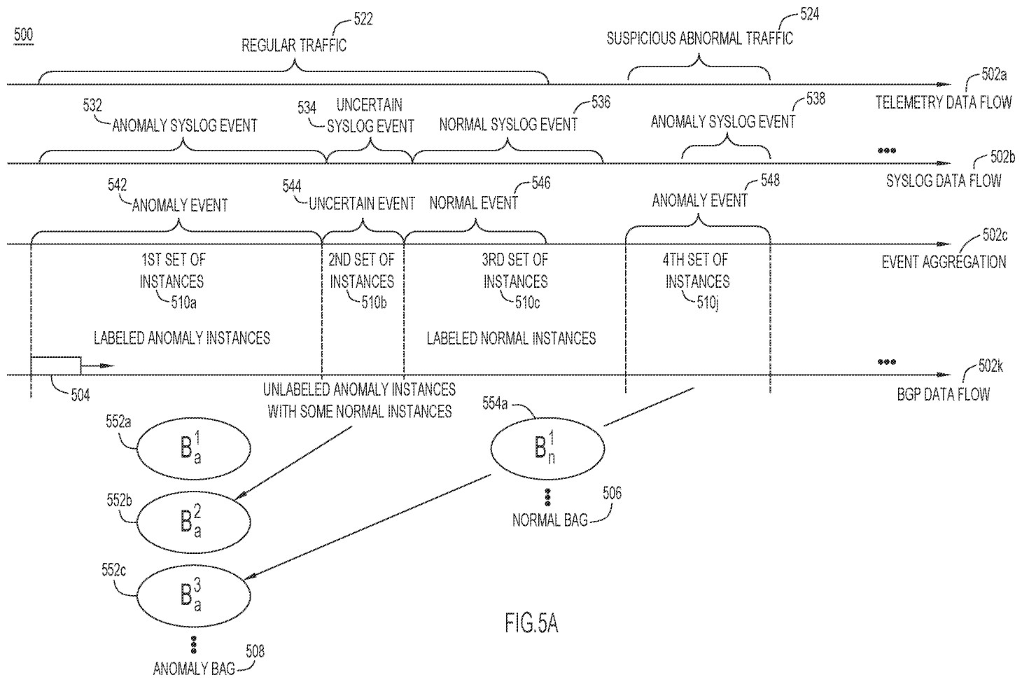

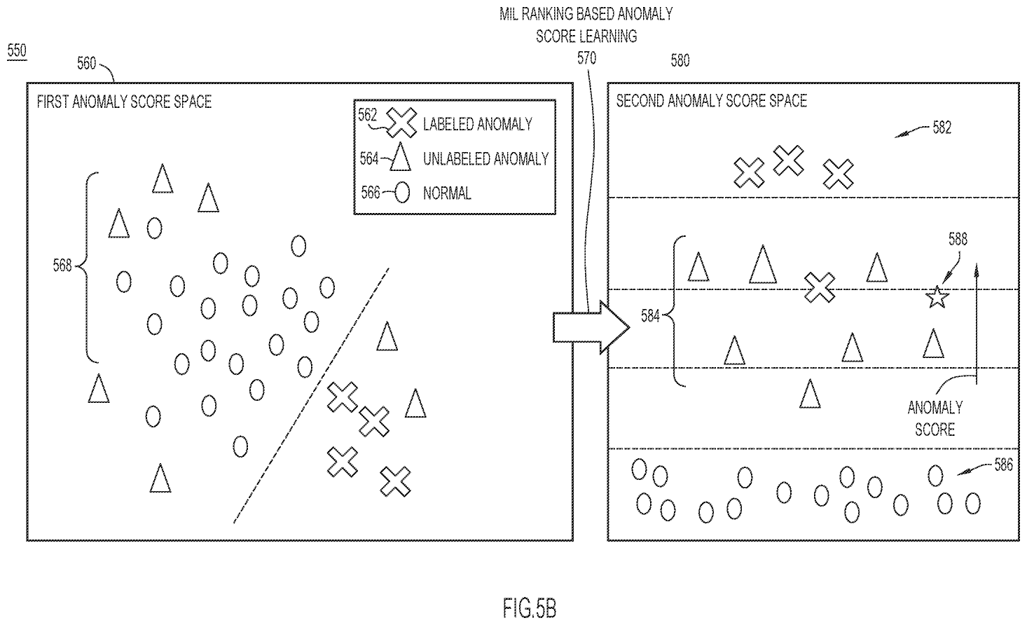

To set a maximum anomaly score value from the anomaly bag 508 of FIG. 5A (Ba) higher than the normal bag 506 of FIG. 5A (Bn), the loss function is applied and involves the following equations (4) and (5):

$$l ( {B}_{a} , {B}_{n} ) = max ( 0 , 1 - {max}_{i ∈ {B}_{a}} f ( {B}_{a}^{i} ) + {max}_{i ∈ {B}_{n}} f ( {B}_{n}^{i} ) ) \qquad ( 4 )$$

$$L ( W ) = l ( {B}_{a} , {B}_{n} ) + ‖ W ‖ \vert \qquad ( 5 )$$

Based on the anomaly score generated by the BGP anomaly detector 230, root cause analysis may be triggered. For example, when the anomaly score is above a preset value 588 (set threshold), root cause analysis is performed by the RCA 240 of FIG. 2. The RCA 240 is configured to determine a root cause of one or more network anomalies by grouping data from the plurality of data sources based on a temporal correlation and a spatial topology correlation. The RCA 240 combines multi-source data using statistical temporal correlation grouping and spatial topology correlation grouping.

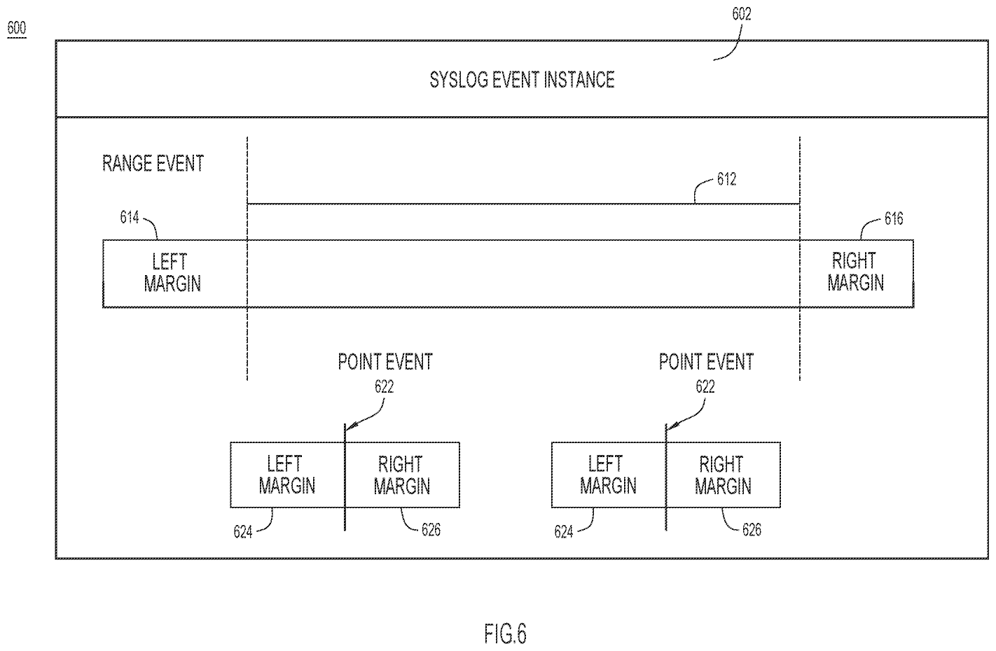

With continued reference to FIG. 1-5B, FIG. 6 is a view illustrating a time window padding 600 in which multi-source data is temporally correlated to determine a root cause of a detected anomaly, according to an example embodiment. The time window padding 600 illustrates temporally correlated a syslog event instance 602 and BGP related telemetry anomaly event (point event 622) with a BGP message.

The temporal correlation involves grouping or joining co-occurrence events based on statistical analysis (e.g., Pearson correlation). Considering various delay timers or expiration timers in each network protocol, there may be inaccuracies and uncertainties in the timing of the network measurements. As such, the time window padding 600 is defined to allow symptom event and diagnostic event to be joined “at the same time”.

For example, the syslog event instance 602 may involve syslog messages or syslog events in a time interval 612 (e.g., 90 seconds time interval). To capture all of the potentially related syslog events, additional time interval may be added before and after the 90 seconds time interval such as a left margin 614 and a right margin 616. The BGP related telemetry anomaly event or the point event 622 may include its own left margin 624 and right margin 626. A telemetry event is a continuous pattern distortion of a predetermined time duration. The syslog event instance 602 and the BGP related telemetry anomaly event are joined with the BGP messages.

The time window padding 600 is one example of extending the time range or the time interval for anomaly events such as the syslog event instance 602. The time window padding 600 may also be applied to BGP messages (updated packets) and/or the MDT.

The RCA 240 further groups multi-source data based on a spatial correlation. When network operators troubleshoot for a symptom event, instead of looking for correlated events occurring throughout the whole network (e.g., network(s) 106 of FIG. 1), the network operators may focus on other events that occur at the same location or proximal location. Spatial information also contributes to locating an anomaly impact scope on the network services. For example, some events may have a local impact, whereas other events may propagate from one location to another. As such, the RCA 240 groups syslog messages and MDT with BGP message based on spatial proximity.

Specifically, the RCA 240 obtains spatial topology information i.e., the router configuration 210c of FIG. 2. The spatial topology information may include logical connections, locations, etc. The RCA 240 then groups relevant anomaly event based on these mappings (spatial proximity). Two events are spatially joined only if they take place on the same router or linked routers/interfaces. In one example embodiment, event groups are cut off if they occur more than L hops away (e.g., L=0, 1, 2) from a location X e.g., the location of the intermediate network device 110b of FIG. 1. L may be set by a user and varies based on a particular deployment and use case scenario.

Table 5 is an example of the router configuration 210c of FIG. 2 (spatial topology information).

| device | Local interface | Remote port | neighbor |
|---|---|---|---|
| dr03 | Hu0/0/0 | Hu0/0/0/26 | Leaf4 |
| dr03 | Hu0/0/30 | Hu0/0/0/26 | Leaf8 |
| dr03 | Hu0/0/1 | Hu0/0/0/27 | Leaf4 |

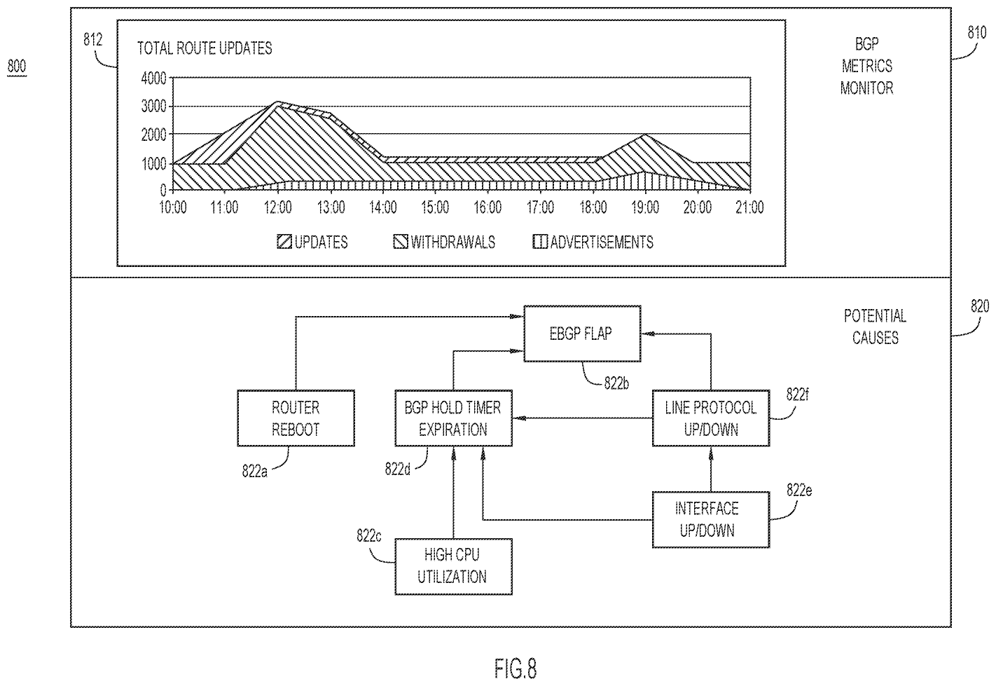

In Table 5, the spatial topology information includes a device identifier, a location interface identifier, a remote port identifier, and a peer device (neighbor identifier). Based on the spatial topology information, the RCA 240 generates correlated event groups such as the ones in FIG. 8, described below.

The RCA 240 further generates a correlation priority score ranking. First, the intersection of the above grouping result is determined as correlated event groups. From the aspect of syslog level, the events are syslog messages that have strong temporal and spatial correlations with the BGP anomaly. From the MDT telemetry level, the events are continuous pattern distortion time range. For each group, the RCA 240 computes a priority score using the equation (6):

$$priority score = {\sum }_{i = 1}^{M} {w}_{{G}_{i}} * log ( {f}_{{G}_{i}} ) , \qquad ( 6 )$$

where W_{Gi} denotes the importance weight assigned to each BGP anomaly event group Gi and f_{Gi} denotes the syslog message occurrence frequency in a time interval or a time duration of the telemetry anomaly event.

By combining a BGP anomaly event (group of features or BGP messages) with multisource data (routing syslog events and MDT), the RCA 240 identifies potential root causes and then the actual root cause, which is based on correlated event groups. Table 6 is an example of root cause types (and potential root cause types) that may be determined based on multisource data correlation analysis.

| anomaly event | |
|---|---|
| group type | Event Description |
| Routing | RIB change |
| | BGP route flapping |
| | BGP neighbor failure |
| | BGP Configuration change |
| | BGP Dampening |
| | IGP route flapping (ISIS, OSPF) |
| | Route table change (local, remote) |
| | VRF change (L2VPN, L3VPN, SR) |
| IP SLA | jitter (TCP, UDP, HTTP, etc) |
| | packet loss (TCP, UDP, HTTP, etc) |
| | delay (TCP, UDP, HTTP, etc) |
| Interface | link or interface flapping / interface |
| | admin status changed |
| | link or interface down / interface |
| | Protocol status changed |
| | line protocol flapping |
| | line protocol down |
| | input data rate high |
| | input errors high |
| | input drops high |
| | output data rate high |
| | output errors high |
| | output drops high |
| Device HW | Router reload/restart |
| | system memory high (system raw memory, |
| | free application memory, free physical memory) |
| | CPU high (average) |
| | CPU high (spike) |
| Device SW | BGP service session restart |
| Security | BGP RPKI issue |
| | BGP TCP session issue (ACL) |
| | BGP TTL issue |
| | BGP Prefix Filtering issue |
| | BGP Route Flap Dampening |
| | BGP Maximum Prefixes reached |
| | BGP Next-Hop issue |

In Table 6, anomaly event group types include, among others, routing issues, device hardware or software issues, BGP service/status, and security issues (risks or violations). That is root causes may one of the following types: a routing network anomaly, a service level agreement anomaly, a failure of an interface of a network device in the enterprise network, a hardware failure of the network device, a software error in the network device, or a network security violation in the enterprise network.

In one example embodiment, for the determined root cause, a configuration action may be generated. That is, the BGP engine 124 of FIG. 1 may generate and perform one or more actions to configure one or more network devices in the enterprise network to remedy the root cause of the issue. The one or more actions may involve reconfiguring an interface of a network device, rerouting traffic to a different interface or link, installing a security patch, upgrading software of the network device, etc.

With continued reference to FIGS. 1-6, FIG. 7 is a view illustrating a BGP monitor user interface 700 for providing information about detected anomalies and potential causes, according to an example embodiment. The BGP monitor user interface 700 includes a plurality of monitoring services 702a-i, tools 704a-h, a specified time interval 706 for which BGP statistics 708 including detected anomalies 712, potential causes 714 (ranked), and a root cause 718, are provided. Optionally, the BGP monitor user interface 700 may further include proposed fixes 720 with one or more actions to configure a network device to fix a detected BGP issue.

In the BGP monitor user interface 700, monitoring services 702a-i include a BGP monitor, device management, system configuration, system health, etc. By selecting one of these monitoring services 702a-i, different types of information about a network may be provided. For example, by selecting the BGP monitor, route stability monitor view is provided to analyze and visualize BGP sessions messages, and collect statistics of various BGP events. By manipulating the tools 704a-h, the user may obtain different views of the BGP. The user may select to view an overview of the BGP, a routing table, an updates browser, a recording, and a BGP session by manipulating the tools 704a-h.

When overview is selected via the tools 704a-h, the user may select a specified time interval 706 and determine the state or stability of the BGP network based on BGP statistics 708. For example, the BGP statistics 708 includes a total BGP messages view 710a where the BGP messages are provided by type (e.g., new advertisements/updates/withdrawals), a peer state view 710b (up or down), total BGP routes 710c (and their states), etc. These are just some non-limiting examples of the BGP statistics 708. The users may thus quickly view the number of BGP events occurring in each time range, evaluate the stability of the BGP network, and locate the time, router information, and BGP routes when a fault occurs.

Additionally, the BGP monitor user interface 700 may further provide BGP faults (detected anomalies 712) detected by the BGP anomaly detector 230. The detected anomalies 712 may include types of faults and anomaly level severity (e.g., from the Table 2 of a BGP-related issue syslog). Moreover, the BGP monitor user interface 700 may provide potential cause of the BGP anomalies (the potential causes 714) that may be ranked by the RCA 240 and the root cause 718 with proposed fixes 720. Potential causes 714 and the root cause 718 may be one of the following types: a routing network anomaly, a service level agreement anomaly, a failure of an interface of a network device in the enterprise network, a hardware failure of the network device, a software error in the network device, or a network security violation in the enterprise network. The BGP monitor user interface 700 may provide additional information about the one or more potential causes of the one or more network anomalies including ranking that indicates likelihood of a respective potential cause being a root cause.

With continued reference to FIGS. 1-7, FIG. 8 is a view illustrating a user interface 800 that provides potential causes of a BGP anomaly ordered by a priority score, according to an example embodiment. The potential causes may be generated by the RCA 240. The user interface 800 includes a BGP metrics monitor 810 and potential causes 820 of detected anomalies.

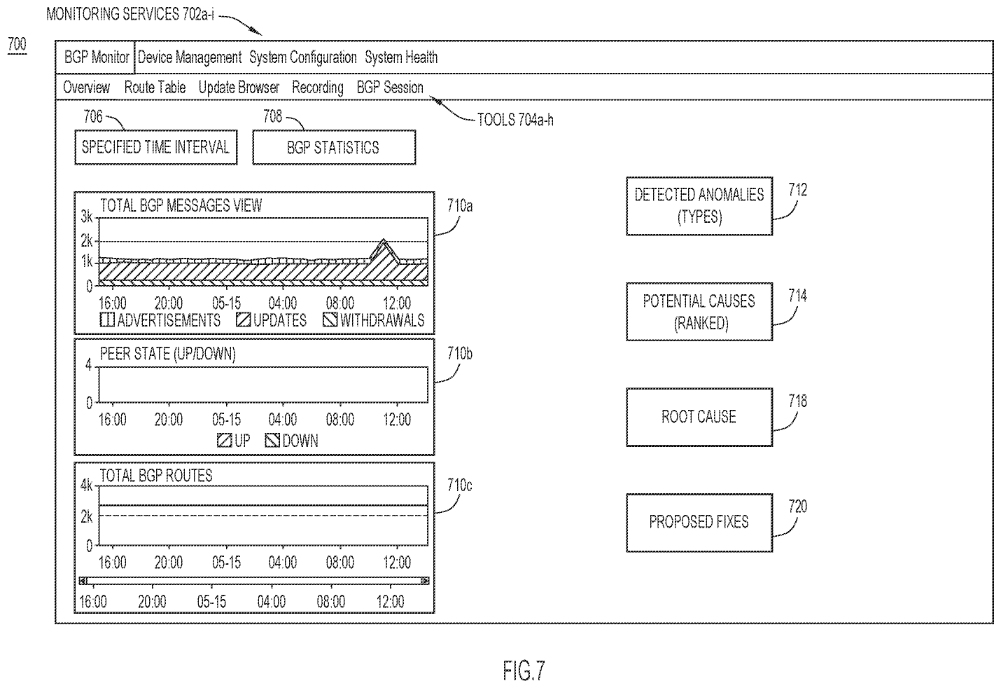

The BGP metrics monitor 810 is configured to provide various BGP statistics such as the BGP statistics 708 of FIG. 7. As an example, the BGP metrics monitor 810 provides total route updates 812 based on event type such as updates, withdrawals, and advertisements.

The potential causes 820 is a correlated syslog event exploration that provides potential BGP event causes 822a-e of a symptom BGP event generated by the RCA 240 based on temporal and spatial correlation groupings. The potential BGP event causes may include a router reboot 822a, an ebgp flap 822b, a high CPU utilization 822c, a BGP hold timer expiration 822d, interface up/down events 822e, and line protocol up/down 822f. These are just some examples of the potential BGP event causes 822a-e (e.g., Table 6). Additionally, the RCA 240 generates interrelationship (grouping) of the events, illustrated by arrows in potential causes 820. Based on these interrelationships, the root cause may be determined by the RCA 240. That is, event interface up/down, event line protocol up/down could be the root cause of the symptom event of the BGP flapping. By ranking various potential causes, the root cause is determined and potential fixes may be generated and provided to the user. That is, the user interface 800 may provide additional information about the one or more potential causes of the one or more network anomalies including ranking that indicates likelihood of a respective potential cause being the root cause.

According to one or more example embodiments, BGP monitor services may display BGP update, advertisements and withdrawals detailed message in real time and in history. Users may check BGP changes that occurred in a particular time interval or at a particular network device. The BGP engine 124 integrates with BGP monitoring services for highlighting BGP event time, identifying correlated anomaly signals, and generating potential root causes of the BGP events.

The techniques presented herein provide an automated BGP event signal labeling and BGP root cause analysis with multiple data sources such as BGP message router syslog and MDT telemetry enhancements. To address labeling uncertainties and in production environments, the techniques presented herein perform multi-instance learning based on weakly supervised learning framework. That is, the techniques presented herein train a BGP anomaly detector based on weakly supervised learning framework. Instead of classifying normal or abnormal data, the BGP anomaly detector learns an anomaly score of a given streaming BGP message.

The techniques presented herein further provide an automated BGP anomaly event labeling engine that combines multiple-source data and automatically assign labels for training the BGP anomaly detector 230 using machine learning. The automated BGP anomaly event labeling engine is configured to extract BGP related features from different data sources (syslog and MDT) while accounting for potential time delays between different data sources and map the extracted features to a particular syslog fault message to describe a BGP issue. The automated BGP anomaly event labeling engine may further apply a syslog anomaly score formula and telemetry metrics forecasting residual analysis to automatically assign anomaly labels to BGP events.

The techniques presented herein provide the BGP anomaly detector that learn from a few labeled known BGP anomalies and detects both known and unknown BGP anomalies using multi-instance learning based on weakly supervised BGP anomaly detection framework. The multi-instance learning is a rank-based anomaly score learning in which graph attention networks are trained by utilizing a ranking loss function and in which the ranking loss between the highest scored instances in the positive bag and the negative bag is computed.

The techniques presented herein further provide a BGP root cause analysis for troubleshooting BGP anomalies/issues. In the root cause analysis, correlated relevant BGP events are identified and grouped with anomaly type tagging support for troubleshooting in one BGP domain SP or enterprise network. The root cause analysis is configured to group co-occurring events based on temporal and spatial correlations.

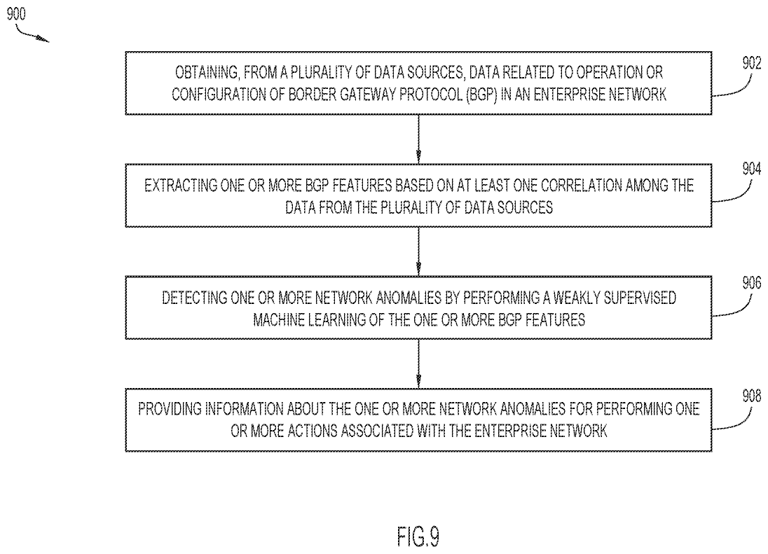

FIG. 9 is a flowchart illustrating a computer-implemented method 900 of providing information about one or more detected network anomalies for performing one or more actions associated with the enterprise network based on weakly supervised machine learning of one or more BGP features, according to an example embodiment. The computer-implemented method 900 may be performed by a computing device of FIG. 10, such as a server, a group of servers, or in a cloud.

The computer-implemented method 900 involves, at 902, obtaining, from a plurality of data sources, data related to operation or configuration of Border Gateway Protocol (BGP) in an enterprise network.

The computer-implemented method 900 further involves at 904, extracting one or more BGP features based on at least one correlation among the data from the plurality of data sources.

The computer-implemented method 900 further involves at 906, detecting one or more network anomalies by performing a weakly supervised machine learning of the one or more BGP features and at 908, providing information about the one or more network anomalies for performing one or more actions associated with the enterprise network.

According to one or more example embodiments, the computer-implemented method 900 may further involve performing the one or more actions to configure one or more network devices in the enterprise network based on the information about the one or more network anomalies.

In one form, the data may include a BGP message, network events data logs, configuration information of a plurality of network devices in the enterprise network, and model-driven telemetry data (MDT). The computer-implemented method 900 may further include assigning, to the BGP message, a BGP label selected from a plurality of BGP labels. The plurality of BGP labels may be generated based on fusing and embedding the network events data logs, the configuration information, and the MDT.

In one instance, the plurality of BGP labels may be coarse anomaly level scores generated based on one or more deviations between a forecasted trend for the data and an actual trend of the data.

According to one or more example embodiments, the data may include network events data logs, configuration information of a plurality of network devices in the enterprise network, and model-driven telemetry data (MDT). The computer-implemented method 900 may further include generating a new BGP label for an unknown BGP anomaly based on fusing and embedding the network events data logs, the configuration information, and the MDT.

In another form, the one or more BGP features may include at least one statistical network feature and at least one network topology feature. The operation 904 of detecting the one or more network anomalies may include generating a graph attention network indicative of one or more interrelationships between the at least one statistical network feature and the at least one network topology feature and generating a ranking-based anomaly score by performing a long short-term memory machine learning of the graph attention network.

In one instance, the operation of generating the graph attention network indicative of the one or more interrelationships between the at least one statistical network feature and the at least one network topology feature may include determining a spatial correlation between volume metric values of the at least one statistical network feature and network layer reachability information metrics of the at least one network topology feature. The operation of generating the graph attention network indicative of the one or more interrelationships between the at least one statistical network feature and the at least one network topology feature may further include determining a temporal correlation between the volume metric values of the at least one statistical network feature and the network layer reachability information metrics of the at least one network topology feature.

According to one or more example embodiments, the computer-implemented method 900 may further include determining a root cause of the one or more network anomalies by grouping the data from the plurality of data sources based on a temporal correlation and a spatial topology correlation.

In one form, the data may include network events data logs, network topology information of a plurality of network devices in the enterprise network, and model-driven telemetry data (MDT). The computer-implemented method 900 may further include generating a first event group by grouping at least two log events in the network events data logs based on a temporal correlation and a spatial topology correlation and generating a second event group based on the MDT, wherein a telemetry event in the second event group is a continuous pattern distortion of a predetermined time duration. The computer-implemented method 900 may further include determining one or more potential causes of the one or more network anomalies by mapping the first event group with the second event group.

In one instance, the computer-implemented method 900 may further involve computing a priority score for each of the first event group and the second event group and correlating the first event group and the second event group based at least in part on the priority score, to determine a root cause of the one or more network anomalies based on the one or more potential causes. The computer-implemented method 900 may further include providing additional information about the root cause of the one or more network anomalies.

In another instance, the root cause may be one of a plurality of root causes types that include at least two of: a routing network anomaly, a service level agreement anomaly, a failure of an interface of a network device in the enterprise network, a hardware failure of the network device, a software error in the network device, or a network security violation in the enterprise network.

According to one or more example embodiments, the computer-implemented method 900 may further involve computing a first priority score of a log event, which indicates an event occurrence frequency within a predefined time interval and computing a second priority score of the telemetry event, which indicates a duration of the telemetry event. The computer-implemented method 900 may further involve ranking the one or more potential causes of the one or more network anomalies based on the first priority score and the second priority score and providing additional information about the one or more potential causes of the one or more network anomalies including ranking that indicates likelihood of a respective potential cause being a root cause.

FIG. 10 is a hardware block diagram of a computing device 1000 that may perform functions associated with any combination of operations in connection with the techniques depicted in FIGS. 1-9, according to various example embodiments, including, but not limited to, operations of the computing device or one or more servers that execute the BGP engine 124 and/or the network controller 122 of FIG. 1. Further, the computing device 1000 may be representative of an apparatus such as one of the network devices, network/computing equipment, or hardware asset of an enterprise (the data source device 102, the data sink device 104, the network source device 110a, the intermediate network device 110b, the network sink device 110n, and/or the telemetry collectors 120a-m, in FIG. 1). It should be appreciated that FIG. 10 provides only an illustration of one example embodiment and does not imply any limitations with respect to the environments in which different example embodiments may be implemented. Many modifications to the depicted environment may be made.

In at least one embodiment, computing device 1000 may include one or more processor(s) 1002, one or more memory element(s) 1004, storage 1006, a bus 1008, one or more network processor unit(s) 1010 interconnected with one or more network input/output (I/O) interface(s) 1012, one or more I/O interface(s) 1014, and control logic 1020. In various embodiments, instructions associated with logic for computing device 1000 can overlap in any manner and are not limited to the specific allocation of instructions and/or operations described herein.

In at least one embodiment, processor(s) 1002 is/are at least one hardware processor configured to execute various tasks, operations and/or functions for computing device 1000 as described herein according to software and/or instructions configured for computing device 1000. Processor(s) 1002 (e.g., a hardware processor) can execute any type of instructions associated with data to achieve the operations detailed herein. In one example, processor(s) 1002 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, one or more memory element(s) 1004 and/or storage 1006 is/are configured to store data, information, software, and/or instructions associated with computing device 1000, and/or logic configured for memory element(s) 1004 and/or storage 1006. For example, any logic described herein (e.g., control logic 1020) can, in various embodiments, be stored for computing device 1000 using any combination of memory element(s) 1004 and/or storage 1006. Note that in some embodiments, storage 1006 can be consolidated with one or more memory elements 1004 (or vice versa), or can overlap/exist in any other suitable manner.

In at least one embodiment, bus 1008 can be configured as an interface that enables one or more elements of computing device 1000 to communicate in order to exchange information and/or data. Bus 1008 can be implemented with any architecture designed for passing control, data and/or information between processors, memory elements/storage, peripheral devices, and/or any other hardware and/or software components that may be configured for computing device 1000. In at least one embodiment, bus 1008 may be implemented as a fast kernel-hosted interconnect, potentially using shared memory between processes (e.g., logic), which can enable efficient communication paths between the processes.

In various example embodiments, network processor unit(s) 1010 may enable communication between computing device 1000 and other systems, entities, etc., via network I/O interface(s) 1012 to facilitate operations discussed for various embodiments described herein. In various embodiments, network processor unit(s) 1010 can be configured as a combination of hardware and/or software, such as one or more Ethernet driver(s) and/or controller(s) or interface cards, Fibre Channel (e.g., optical) driver(s) and/or controller(s), and/or other similar network interface driver(s) and/or controller(s) now known or hereafter developed to enable communications between computing device 1000 and other systems, entities, etc. to facilitate operations for various embodiments described herein. In various example embodiments, network I/O interface(s) 1012 can be configured as one or more Ethernet port(s), Fibre Channel ports, and/or any other I/O port(s) now known or hereafter developed. Thus, the network processor unit(s) 1010 and/or network I/O interface(s) 1012 may include suitable interfaces for receiving, transmitting, and/or otherwise communicating data and/or information in a network environment.

I/O interface(s) 1014 allow for input and output of data and/or information with other entities that may be connected to computing device 1000. For example, I/O interface(s) 1014 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a display 1016 such as a computer monitor, a display screen, or the like.

In various example embodiments, control logic 1020 can include instructions that, when executed, cause processor(s) 1002 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

In another example embodiment, an apparatus is provided. The apparatus includes a memory, a network interface configured to enable network communications, and a processor. The processor of the apparatus is configured to perform a method including obtaining, from a plurality of data sources, data related to operation or configuration of Border Gateway Protocol (BGP) in an enterprise network and extracting one or more BGP features based on at least one correlation among the data from the plurality of data sources. The method further involves detecting one or more network anomalies by performing a weakly supervised machine learning of the one or more BGP features and providing information about the one or more network anomalies for performing one or more actions associated with the enterprise network.

In yet another example embodiment, one or more non-transitory computer readable storage media encoded with instructions are provided. When the media is executed by a processor, the instructions cause the processor to execute a method that involves obtaining, from a plurality of data sources, data related to operation or configuration of Border Gateway Protocol (BGP) in an enterprise network and extracting one or more BGP features based on at least one correlation among the data from the plurality of data sources. The method further involves detecting one or more network anomalies by performing a weakly supervised machine learning of the one or more BGP features and providing information about the one or more network anomalies for performing one or more actions associated with the enterprise network.

In yet another example embodiment, a system is provided that includes the devices or apparatuses and operations explained above with reference to FIGS. 1-10.

The programs described herein (e.g., control logic 1020) may be identified based upon the application(s) for which they are implemented in a specific embodiment. However, it should be appreciated that any particular program nomenclature herein is used merely for convenience, and thus the embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, the storage 1006 and/or memory elements(s) 1004 can store data, software, code, instructions (e.g., processor instructions), logic, parameters, combinations thereof, and/or the like used for operations described herein. This includes the storage 1006 and/or memory elements(s) 1004 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein, the terms may be used in a generic sense to include packets, frames, segments, datagrams, and/or any other generic units that may be used to transmit communications in a network environment. Generally, the terms reference to a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data, or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A computer-implemented method comprising:
obtaining, from a plurality of data sources, data related to operation or configuration of Border Gateway Protocol (BGP) in an enterprise network;
extracting one or more BGP features based on at least one correlation among the data from the plurality of data sources;
detecting one or more network anomalies by performing a weakly supervised machine learning of the one or more BGP features; and
providing information about the one or more network anomalies for performing one or more actions associated with the enterprise network.

2. The computer-implemented method of claim 1, further comprising:
performing the one or more actions to configure one or more network devices in the enterprise network based on the information about the one or more network anomalies.

3. The computer-implemented method of claim 1, wherein the data includes a BGP message, network events data logs, configuration information of a plurality of network devices in the enterprise network, and model-driven telemetry data (MDT) and further comprising:
assigning, to the BGP message, a BGP label selected from a plurality of BGP labels, wherein the plurality of BGP labels are generated based on fusing and embedding the network events data logs, the configuration information, and the MDT.

4. The computer-implemented method of claim 3, wherein the plurality of BGP labels are coarse anomaly level scores generated based on one or more deviations between a forecasted trend for the data and an actual trend of the data.

5. The computer-implemented method of claim 1, wherein the data includes network events data logs, configuration information of a plurality of network devices in the enterprise network, and model-driven telemetry data (MDT) and further comprising:
generating a new BGP label for an unknown BGP anomaly based on fusing and embedding the network events data logs, the configuration information, and the MDT.

6. The computer-implemented method of claim 1, wherein the one or more BGP features include at least one statistical network feature and at least one network topology feature and detecting the one or more network anomalies includes:
generating a graph attention network indicative of one or more interrelationships between the at least one statistical network feature and the at least one network topology feature; and
generating a ranking-based anomaly score by performing a long short-term memory machine learning of the graph attention network.

7. The computer-implemented method of claim 6, wherein generating the graph attention network indicative of the one or more interrelationships between the at least one statistical network feature and the at least one network topology feature includes:
determining a spatial correlation between volume metric values of the at least one statistical network feature and network layer reachability information metrics of the at least one network topology feature; and
determining a temporal correlation between the volume metric values of the at least one statistical network feature and the network layer reachability information metrics of the at least one network topology feature.

8. The computer-implemented method of claim 1, further comprising:
determining a root cause of the one or more network anomalies by grouping the data from the plurality of data sources based on a temporal correlation and a spatial topology correlation.

9. The computer-implemented method of claim 1, wherein the data includes network events data logs, network topology information of a plurality of network devices in the enterprise network, and model-driven telemetry data (MDT) and further comprising:
generating a first event group by grouping at least two log events in the network events data logs based on a temporal correlation and a spatial topology correlation;
generating a second event group based on the MDT, wherein a telemetry event in the second event group is a continuous pattern distortion of a predetermined time duration; and
determining one or more potential causes of the one or more network anomalies by mapping the first event group with the second event group.

10. The computer-implemented method of claim 9, further comprising:
computing a priority score for each of the first event group and the second event group;
correlating the first event group and the second event group based at least in part on the priority score, to determine a root cause of the one or more network anomalies based on the one or more potential causes; and
providing additional information about the root cause of the one or more network anomalies.

11. The computer-implemented method of claim 10, wherein the root cause is one of a plurality of root causes types that include at least two of:
a routing network anomaly,
a service level agreement anomaly,
a failure of an interface of a network device in the enterprise network,
a hardware failure of the network device,
a software error in the network device, or
a network security violation in the enterprise network.

12. The computer-implemented method of claim 9, further comprising:
computing a first priority score of a log event, which indicates an event occurrence frequency within a predefined time interval;
computing a second priority score of the telemetry event, which indicates a duration of the telemetry event;
ranking the one or more potential causes of the one or more network anomalies based on the first priority score and the second priority score; and
providing additional information about the one or more potential causes of the one or more network anomalies including ranking that indicates likelihood of a respective potential cause being a root cause.

13. An apparatus comprising:
a memory;
a network interface configured to enable network communications; and
a processor, wherein the processor is configured to perform a method comprising:
obtaining, from a plurality of data sources, data related to operation or configuration of Border Gateway Protocol (BGP) in an enterprise network;
extracting one or more BGP features based on at least one correlation among the data from the plurality of data sources;
detecting one or more network anomalies by performing a weakly supervised machine learning of the one or more BGP features; and
providing information about the one or more network anomalies for performing one or more actions associated with the enterprise network.

14. The apparatus of claim 13, wherein the processor is further configured to:
perform the one or more actions to configure one or more network devices in the enterprise network based on the information about the one or more network anomalies.

15. The apparatus of claim 13, wherein the data includes a BGP message, network events data logs, configuration information of a plurality of network devices in the enterprise network, and model-driven telemetry data (MDT) and the processor is further configured to perform:
assigning, to the BGP message, a BGP label selected from a plurality of BGP labels, wherein the plurality of BGP labels are generated based on fusing and embedding the network events data logs, the configuration information, and the MDT.

16. The apparatus of claim 15, wherein the plurality of BGP labels are coarse anomaly level scores generated based on one or more deviations between a forecasted trend for the data and an actual trend of the data.

17. One or more non-transitory computer readable storage media encoded with software comprising computer executable instructions that, when executed by a processor, cause the processor to perform a method including:
obtaining, from a plurality of data sources, data related to operation or configuration of Border Gateway Protocol (BGP) in an enterprise network;
extracting one or more BGP features based on at least one correlation among the data from the plurality of data sources;
detecting one or more network anomalies by performing a weakly supervised machine learning of the one or more BGP features; and
providing information about the one or more network anomalies for performing one or more actions associated with the enterprise network.

18. The one or more non-transitory computer readable storage media according to claim 17, wherein the computer executable instructions cause the processor to:
perform the one or more actions to configure one or more network devices in the enterprise network based on the information about the one or more network anomalies.

19. The one or more non-transitory computer readable storage media according to claim 17, wherein the data includes a BGP message, network events data logs, configuration information of a plurality of network devices in the enterprise network, and model-driven telemetry data (MDT) and the computer executable instructions cause the processor to perform:
assigning, to the BGP message, a BGP label selected from a plurality of BGP labels, wherein the plurality of BGP labels are generated based on fusing and embedding the network events data logs, the configuration information, and the MDT.

20. The one or more non-transitory computer readable storage media according to claim 19, wherein the plurality of BGP labels are coarse anomaly level scores generated based on one or more deviations between a forecasted trend for the data and an actual trend of the data.
